(19) United States
(12) Patent Application Publication
(10) Pub. No.: US 2005/0096909 A1
(43) Pub. Date: May 5, 2005

(54) Systems and methods for expressive text-to-speech

(76) Inventors: Raimo Bakis, Briarcliff Manor, NY (US); Andrew Aaron, Ardsley, NY (US); Ellen M. Eide, Bedford, NY (US); Thiruvilwamalai V. Raman, San Jose, CA (US)

Correspondence Address: BMT/IBM, FIVE ELM STREET, NEW CANAAN, CT, 06840, US

(21) Appl. No.: 10/695,979

(22) Filed: Oct. 29, 2003

(51) Int. Cl. G10L 13/00

(52) U.S. Cl. 704/260

(57) ABSTRACT

Systems and methods are provided for expressive text-to-speech which include identifying text to convert to speech, selecting a speech style sheet from a set of available speech style sheets, the speech style sheet defining desired speech characteristics, marking the text to associate the text with the selected speech style sheet, and converting the text to speech having the desired speech characteristics by applying a low level markup associated with the speech style sheet.

### FIELD

The present invention relates to text-to-speech (TTS) systems. In particular, the present invention relates to systems and methods for expressive TTS.

### BACKGROUND

Text to speech systems are increasing in popularity and versatility. These systems allow text to be converted into spoken words. For example, using text to speech techniques, an electronic mail program can be configured to read an electronic mail message. Most text to speech conversions result in spoken words that are non-expressive, monotonic, or generally sound as if they were spoken by a machine rather than a human.

Voice experts are able to convert text to speech in an expressive manner. This can be quite time consuming and complicated, requiring a knowledge of speech characteristics and the ability to define speech requirements for particular expressions. A typical developer does not have the time or expertise to define the tone, volume, pitch, timbre, breathiness or other speech properties associated with a message to be spoken via, for example, a voice response unit. Similarly, voice experts (such as sound engineers or the like) do not typically write text to speech scripts or applications.

### SUMMARY

Embodiments of the present invention introduce systems, methods, apparatus, computer program code, and means for expressive text-to-speech (TTS).

According to some exemplary embodiments, systems, methods, apparatus, computer program code, and means are provided which include a method which includes identifying text to convert to speech, selecting a speech style sheet from a set of available speech style sheets, the speech style sheet defining desired speech characteristics, marking the text to associate the text with the selected speech style sheet, and converting the text to speech having the desired speech characteristics by applying a low level markup associated with the speech style sheet.

According to some exemplary embodiments speech style sheets are provided which include a voice style associated with a voice-type, the voice style relating a high level markup of the voice-type to a low level markup of the voice-type.

Some exemplary embodiments include an apparatus with a processor having access to at least one speech style sheet, the at least one speech style sheet containing a definition of a voice style associated with a voice-type, and the definition relating a high level markup of the voice-type to a low level markup of the voice-type. The processor is also operative to convert the high level markup to the low level markup. The apparatus further includes a user interface device for applying the at least one voice style to text associated with the voice-type, the user interface being in communication with the processor, and an output device connected to the processor for converting the text with the low level markup to speech.

According to some exemplary embodiments a system is provided having a designer device for creating speech style sheets, a speech style sheet at least partially created by the designer device, the speech style sheet defining a voice style, a text-to-speech device for receiving text associated with a voice-type, the text having a high level markup associated with the voice style, and the text-to-speech device having access to the speech style sheet. The text-to-speech device also has a memory for storing computer executable code, and a processor for executing the program code stored in memory. The program code may include code to determine, by accessing the speech style sheet, a low level markup associated with the high level markup, and code to convert the high level markup of the text to the low level markup. The system also may include an output device for producing expressive speech using the text with the low level markup, the output device being in communication with the text-to-speech device.

With these and other advantages and features of embodiments that will become hereinafter apparent, embodiments may be more clearly understood by reference to the following detailed description, the appended claims, and the drawings attached herein.

### BRIEF DESCRIPTION OF THE DRAWINGS

FIG. 1 is a flow diagram of a method according to some embodiments.

FIG. 2 is a block diagram of a speech style sheet according to some embodiments.

FIG. 3 is a block diagram of a text-to-speech (TTS) system according to some embodiments.

FIG. 4 is a block diagram of a TTS system according to some embodiments.

FIG. 5 is a block diagram of an apparatus according to some embodiments.

### DETAILED DESCRIPTION

Expressive voice capabilities for text-to-speech (TTS) systems and devices have been limited and are typically available only to speech experts. Some embodiments herein describe systems, methods, apparatus, computer program code, and means for expressive TTS which overcome these, and other, shortcomings.

Definitions

For clarity and ease of explanation, a number of terms are used herein. For example, as used herein, the phrase “voice-type” generally refers to a voice, and/or a spoken or oral expression of a particular language, gender, nationality, or type. Examples of voice-types include, but are not limited to, male, female, English-speaking, American (female), German (German-speaking female), and Cornish (male voice speaking English with a Cornish accent). Voice-types may be identified by a common name, label, and/or other identifier. For example, a voice-type for a male voice speaking in common English with a Southern U.S. accent may be identified by the name “Southern U.S. Male”. Voice-types may be defined by and/or contain definitions for one or more low level markups indicating how a particular voice type is to be produced, sounded, and/or spoken.

As used herein, the term “low level markup” generally refers to a rule, definition, guideline, parameter, and/or program code, object, or module that contains and/or is indicative of information associated with how or what sound is to be produced. For example, a line of program code may indicate that a sound is to be produced at a pitch of forty cycles per second (or forty Hertz). In a TTS context, text defined by and/or associated with the low level markup defining pitch may be spoken at that particular pitch. In general terms, a low level markup may define any number and/or combination of speech properties and/or pronunciation rules. For example, a low level markup may indicate that a certain word or phrase be spoken in certain circumstances. The word or phrase may be an addition and/or alteration to the text to be converted to speech.

As used herein, the term “text” generally refers to any text, character, symbol, other visual indicator, or any combination thereof. For example, text may be or include structured information such as extensible markup language (XML) or other markup, tags, and/or programming code. In some embodiments for example, text may include XML markup defining airline flight characteristics to be spoken in an interactive voice response (IVR) system.

As used herein, the term “speech properties” generally refers to any characteristic and/or combination of characteristics associated with the production of sound or speech. Speech properties may include any value, variable, characteristic, and/or other property that may be used to define the sounds that comprise speech and/or govern how those sounds are produced. For example, speech properties may include, but are not limited to pitch (or frequency, or wavelength), timbre, harmonics (or overtones), loudness (or intensity, or volume), prosody (timing and intonation), quality, tone, duration (or sustain), tremor, speed, onset (or attack), breathiness, and decay.

As used herein, the term “voice style” generally refers to a manner and/or style of speech. Voice styles may define either and/or both of a low level markup and a high level markup associated with a particular style or manner of speaking. For example, a voice style may be “happy”, “annoyed”, “playful”, “formal”, “Engineering” or “hoarse”. Some voice styles (like “happy”, for example) may define expressive styles or manners of speech such as how a “happy” voice sounds. In some embodiments, a voice style such as “happy” may indicate that text to be converted to speech be preceded (or succeeded) by a particular word or phrase. Other voice styles (like “Engineering”, for example) may define one or more pronunciation rules associated with a style, manner, or category of speech. The low level markup defined by a particular voice style may correspond and/or be related or associated with a high level markup identifying, representing, and/or indicating the particular voice style.

As used herein, the term “high level markup” generally refers to any notation, highlighting, mark, designation, annotation, and/or any other method of associating an item (such as text) with another item, definition, and/or description (such as the low level markup associated with a voice style). For example, a text annotation such as “underlining” may indicate and/or be associated with a particular voice style. The underlined text may then be spoken using the low level markup defined by the associated voice style. In some embodiments, a low level markup may be or include a different level of high level markup. For example, a first high level markup may refer to a first low level markup. The first low level markup may include a second high level markup that refers to a second low level markup. In such embodiments, a hierarchy of high and low level markup combinations may be used to define various voice styles and/or voice types.

As used herein, the term “speech style sheet” generally refers to an association of one or more voice-types and/or voice styles. Speech style sheets may be any known or available types of objects, devices, rules, processes, procedures, instructions, programs, codes, definitions, and/or descriptions, or any combination thereof, that relate and/or define one or more voice-types and/or voice styles. For example, a speech style sheet may be a computer program and/or file that contains definitions for a group of related voice styles. The voice styles may be a grouping, for example, of all common expressive voice styles (“happy”, “sad”, “angry”, etc.) for a particular voice-type (like the voice-type “Southern U.S. Male”). In some embodiments, a speech style sheet may also relate and/or define one or more other speech style sheets, voice-types, and/or voice styles.

As used herein, the terms “designer”, “text-to-speech designer”, and “TTS designer”, may be used interchangeably and generally refer to any person, individual, team, group, entity, device, and/or any combination thereof that creates and/or edits style sheets such as the speech style sheets described herein. For example, a TTS designer may be a programmer with expertise in coding programs for the aural, oral, and/or performing voice arts. Such a programmer may, for example, be skilled in designing voice styles and/or voice-types.

As used herein, the terms “developer”, “text-to-speech developer”, and “TTS developer”, may be used interchangeably and generally refer to any person, individual, team, group, entity, device, and/or any combination thereof that creates and/or edits text-to-speech presentations. For example, a TTS developer may be a programmer with expertise in coding IVR menus.

As used herein, the term “text-to-speech presentation” (or “TTS presentation”) generally refers to a textual work (a character, word, phrase, sentence, book, web page, script, program code, markup, etc.) which is converted to and/or designed to be converted to speech. Examples of TTS presentations are provided throughout herein, and may include, but are not limited to, IVR menus, auditory web pages, and regular web pages, textual documents, and online chat and/or e-mail text converted to and/or intended to be converted to speech.

Method

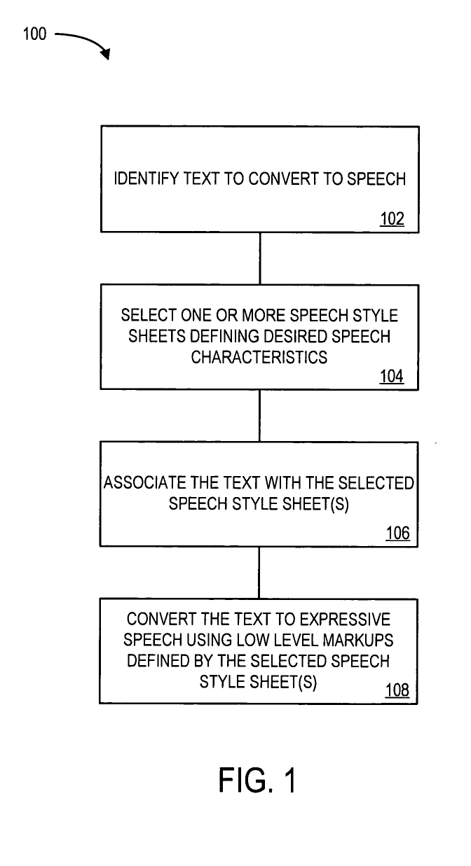

Referring now to FIG. 1, a flow diagram of a method 100 according to some embodiments is shown. The flow diagram in FIG. 1 and the other figures described herein do not imply a fixed order of steps, and embodiments may be practiced in any order that is practicable. The method 100 of FIG. 1 may be performed, for example, by a TTS system or apparatus and/or one or more of its components as described herein. According to some embodiments, the method 100 may be performed by or using a TTS developer device, also as described herein. The method 100 may begin, for example, by identifying text to convert to speech at 102. For example, a TTS developer may operate a computer having a graphical user interface (GUI). The GUI may be associated with any of various programs including word processors, spreadsheets, and TTS programs and/or applications. Text that is typed, written, scanned, or otherwise entered into such a program associated with the GUI may be identified by the developer as being appropriate for markup.

As an illustrative example (which will be continued throughout the following discussion of FIG. 1), the developer may be an IVR menu programmer designing an IVR menu system for an Airline's automated flight reservation system. The developer may select text within the program by using the GUI in conjunction with one or more input devices. In some embodiments, the developer may mark text by inserting tags or other markings. In embodiments where the GUI is used to facilitate marking or selection, for example, the developer may use a mouse or other pointing device to highlight the text desired to be converted to speech. In some embodiments, the developer may write or otherwise design the IVR menu within or using a TTS program. The text desired for conversion to speech may, for example, be identified implicitly by having been entered into the TTS program. As a specific example, the developer may want to convert customer information from a text phrase to speech. In some embodiments, the developer may do so by typing the text directly into a TTS program. As a specific example, the developer may enter the text “flight departs from runway 22L”. That is, in the example, the entered text has been identified as text to be converted to speech.

Pursuant to some embodiments, the developer has access to a library or collection of style sheets (e.g., which may have been previously created by one or more designers skilled in the art of defining expressive speech qualities). Each of the style sheets may be identified by a descriptive identifier allowing the developer to easily select from among a number of available sheets.

The developer may select from among the available speech style sheets to associate the selected and/or identified text with one or more voice styles, voice-types, or combinations of voice styles and voice-types. At 104, for example, the developer may select a speech style sheet from a speech style sheet library or other source of style sheets. For example, the developer may use a mouse or other pointing device to select a style sheet from a pull-down, pop-up, or other menu in the GUI. The menu may contain a list or grouping of one or more speech style sheets available for the developer's use. As described herein, the speech style sheet selected may be associated with and/or define any number of voice styles, voice-types, other speech style sheets, and/or combinations thereof. In some embodiments, selection of the speech style sheet may load the speech style sheet into memory and/or may initialize and/or modify a toolbar in the GUI for uses associated with the speech style sheet. Continuing the specific example introduced above, the developer may choose to use a speech style sheet named “Aviation” from a list of available speech style sheets.

Processing continues at 106 where the developer marks the selected and/or identified text to associate it with the speech style sheet. This may further include associating the text with one or more voice styles and one or more voice-types associated with the speech style sheet. For example, the developer may use a mouse or other pointing device to select a toolbar button associated with a voice style associated with the speech style sheet. Continuing the example introduced above, the selected style sheet labeled “Aviation” may contain definitions of several voice styles (labeled “formal” and “informal”). Further, each voice style may be associated with the voice-types “Female” and “Male”. When the speech style sheet labeled “Aviation” is loaded and/or selected, a pull-down list of the available voice-types, and toolbar buttons associated with the two available voice styles appear. The developer may choose (from the pull-down list) the voice-type labeled “Female” for example. The selected text will then be associated with the voice-type labeled “Female”, and will thus be spoken in a female voice in accordance with the low level markup defined by the voice-type. The developer may also select the toolbar button “formal” to associate the selected text with the voice style labeled “formal”. The selected text would then be spoken in accordance with the combination of low level markups defined by the respective voice style and voice-type selected by the developer (a formal female voice).

These high level markups applied to the selected text by the developer may include visual or other representations of the chosen voice styles or fonts, or may be transparently associated with any selected voice styles and/or fonts. For example, the selection of the voice-type labeled “Female” from the pull-down list in the GUI may associate the selected text with the voice-type, but may only do so, for example, in the code defining the properties of the text. In some embodiments, the association may be codified in the properties of an object-oriented programming object representing the text, for example. The text itself may not change in appearance, form, or substance. The selection of the “formal” toolbar button however, may cause the selected text to be “underlined” or otherwise annotated. Thus, any underlined text in the TTS document may be readily identified as being associated with a particular voice style or voice-type (in this case, with the voice style labeled “formal”).

Processing may continue at 108 where the selected text is converted to speech. The production of the speech and/or the TTS operations may be performed by, for example, a TTS program running on the developer's computer. In some embodiments, the developer may select a menu item and/or select a toolbar button to command the program to convert the text to speech. The conversion of the text to speech may involve, according to some embodiments, converting the high level markup (like the underlining) to the low level markup defined by the appropriate speech style sheet, voice style, and/or voice-type. In other embodiments, the high level markup may be replaced by the low level markup, or the low level markup may simply be identified and used in lieu of the high level markup. The low level markup may be read or otherwise interpreted by the TTS program and used to produce the speech in accordance with the styles, rules, qualities, and/or characteristics associated with the respective style sheet, voice style, and/or voice font. The identified text “flight departs from runway 22L” of the current example, for instance, is associated with a voice-type labeled “Female” and a voice style labeled “formal”. Processing at 108 for this example may include the application of the low level markups associated with the voice-type labeled “Female” and the voice style labeled “formal” to produce the phrase in a formal female voice.

According to some embodiments, the style sheet selected may contain definitions of speech properties and/or other speech rules including pronunciation rules. In the current example for instance, the speech style sheet “Aviation” may contain rules defining how certain characters, words, and/or phrases should be pronounced to comply with speech relating to the category or field of aviation. For example, the portion of the selected phrase “22L” may normally be pronounced as “22 el”. However, in an aviation context, the “L” stands for and is pronounced as “Left” (indicating runway twenty-two left). Thus, according to some embodiments, a pronunciation and/or other speech rule may be applied to the selected text in association with the selected style sheet. In some embodiments, the speech style sheet and respective rules may be associated with an entire TTS document and/or presentation. Also according to some embodiments, either or both of a voice style and a voice-type may also contain and/or define such pronunciation and/or other speech-related rules.

Thus, use of the speech style sheets as described herein may result in an applied hierarchy of rules and/or definitions for use in converting text to speech. In the present example, for instance, the TTS developer may produce several pages of text for use in an IVR menu system. The entire document (all of the text on all of the pages) may be associated with the speech style sheet named “Aviation” and thus may be pronounced using the rules defined by or associated with the “Aviation” category of speech (as defined by the speech style sheet, in this case). The first page of the document may be associated with the voice-type referred to as “Female”, while the remaining pages are associated with the voice-type referred to as “Male”. Certain portions of selected text and/or individual words within either the “Female” or “Male” sections of the document may further be defined by the voice styles “formal” or “informal”. Those skilled in the art will recognize that any combination of speech style sheets, voice styles, and/or voice-types may be applied to any portions, characters, words, or phrases of a TTS presentation.

Methods according to some embodiments may include other processes and/or procedures related to the production of expressive TTS. For example, in some embodiments a designer may define, create, and/or edit a speech style sheet, voice style, voice-type, or any combination thereof. The designer may have expertise in designing speech style sheets, voice styles, and/or voice-types. In some embodiments, a library of speech style sheets may be created and/or made available to a developer and/or a device capable of performing TTS operations (such as a TTS device as described herein). The developer (who may have IVR menu development expertise, but may lack expertise in the voice arts) may utilize the speech style sheets, voice styles, and voice-types created and/or edited by the designer to produce expressive TTS presentations. In some embodiments, the developer may also be permitted to create and/or edit style sheets, voice styles, and/or voice-types.

Speech Style Sheet

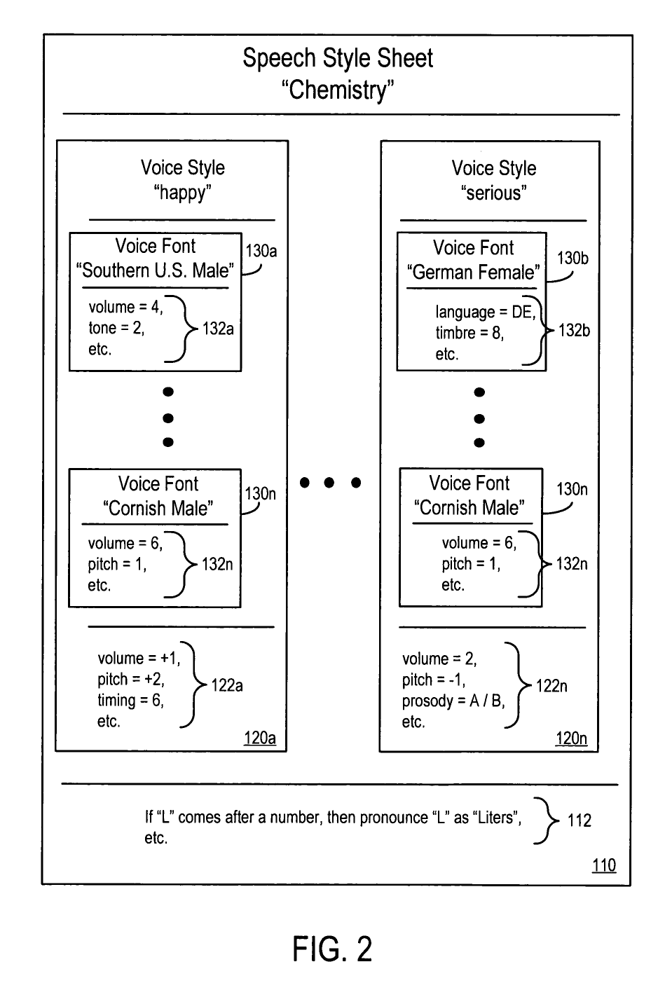

Turning now to FIG. 2, a block diagram of a speech style sheet 110 according to some embodiments is shown. As described herein, one or more speech style sheets 110 may be used by or within a TTS system. For example, a library or database of speech style sheets 110 may be created by a designer for use by one or more developers. Each speech style sheet 110 may be associated with any number of voice styles 120a-n. Further, each voice style 120a-n may be associated with one or more voice-types 130a-n. Each voice style 120a-n may be associated with the same or different voice-types 130a-n. For example, voice style 120a may be associated with voice-types 130a-130n, while voice style 120n may be associated with voice-types 130b-130n. Thus, voice style 120a may be associated with voice-type 130a, and not with voice-type 130b, while voice style 120n may be associated with voice-type 130b, and not voice-type 130a. Both voice styles 120a, 120n may be associated with the same voice-type 130n.

As a specific illustrative example, the speech style sheet 110 may define a first voice style 120a, having two associated voice-types 130a, 130n. In the illustrative example, the voice-types associated with speech style sheet 110 are a voice-type labeled “Southern U.S. Male” (representing a male voice speaking in common English with a Southern U.S. accent), and a voice-type labeled “Cornish Male” (representing a male voice speaking common English with a Cornish accent).

The voice-types 130a, 130n define a particular type of voice to be used when the voice-types 130a, 130n are used to produce speech. For example, when text is marked with the voice-type labeled “Southern U.S. Male” (voice-type 130a) and is selected for conversion to speech the marked text may be spoken in a deep tone (male), and slower than average with either a slight or heavy “drawl” (such characteristics being common to Southern speech). The speech properties defining exactly how the voice-type labeled “Southern U.S. Male” 130a sounds may be stored in the speech style sheet 110, for example, as the low level markup 132a. The low level markup 132a of the present example assigns numeric values to certain speech properties. For example, the volume associated with the voice-type labeled “Southern U.S. Male” 130a is represented as “four” (on a scale of one to ten, with ten being the loudest, for example). The tone associated with the voice-type labeled “Southern U.S. Male” 130a is given the value of “two”, which may indicate for example, a low tone.

Similarly, the voice-type referred to as “Cornish Male” 130n may be associated with a low level markup 132n. The low level markup 132n may define, for example, a higher than average volume of “six” and a pitch of “one”. The low level markups 130a, 130n may define any known or available speech property, characteristic, pronunciation rule, or any combination thereof. Some speech properties may be defined by scale values (like the volume on a scale of one to ten, for example) and others may be defined by numeric identifiers that relate to particular values, properties, or characteristics. For example, the low level markup 132n for the voice-type referred to as “Cornish Male” 130n defines pitch as having a value of “one”. The value “one” may refer, for example, to a low pitch identified by a particular frequency (like twenty Hertz). In some embodiments, the low level markup 132 may further define which language the voice-type 130 is to be spoken in. For example, the voice-type “German Female” 130b associated with the voice style labeled “serious” 120n may include the low level markup 132b. The low level markup 132b specifies a language parameter as “DE”, which may indicate for example, that the associated text should be spoken in “Deutsch” (or German).

Each of the voice-types 130a, 130n is associated with and further defined by the voice style 120a. The voice style 120a defines a particular voice quality, personality, style, and/or kind with which the voice-types 130a, 130n are to be spoken. For a given voice-type 130a, 130n, the voice style 120a defines how words within that voice-type 130a, 130n are to be pronounced and/or produced. Continuing the illustrative example, the voice style 120a is identified by the name “happy”. The definition of the “happy” voice style 120a includes one or more variables, values, and/or definitions designed to specify how a “happy” voice may sound. In some embodiments, the definition of a voice style 120 may include one or more definitions of various speech properties. For example, the voice style named “happy” 120a may include the low level markup 122a. The low level markup 122a may define any speech property, characteristic, or pronunciation rule known, available, and/or described herein.

In the illustrative example, the low level markup 122a defines volume, for example, as having a relative value of “plus one”. Similarly, low level markup 122a defines pitch as having a relative value of “plus two”. In some embodiments, these relative values may further define any and/or all associated voice-types 130a-130n. The low level markup 122 may also define one or more speech characteristics in more complex relative terms. For example, the voice style labeled “serious” 120n may include the low level markup 122n. The low level markup 122n defines speech prosody by the generic formula “A/B”. The formula may be any know or available formula for calculating, determining, and/or defining a speech property or characteristic. The variables “A” and “B” may represent any properties, values, constants, characteristics, and/or other formulas or mathematical expressions.

In the illustrative example, text marked as being associated with the voice-type named “Southern U.S. Male” 130a and the voice style referred to as “happy” 120a may be produced at a volume of “five”. Thus, a “happy” representation of the “Southern U.S. Male” voice-type 1 30a may be expressively produced by increasing the normal volume of the voice-type named “Southern U.S. Male” 130a by the relative value of “one” indicated by the low level markup 122a. Similarly, a “happy” representation of the voice-type referred to as “Cornish Male” would be produced at a volume of “seven” and a pitch of “three”. In some embodiments, the low level markup 122a may also and/or alternatively define speech properties using absolute values. For example, the timing value of “six” defined by the low level markup 122a may indicate that all associated voice-types 130a, 130n are to be produced using a speech timing of “six”. Such a definition may override any definitions for the given parameter found in the individual voice-types 130a, 130n, or may be a speech property reserved for definition by a voice style 120. According to some embodiments, although a voice style may define a speech property for all associated voice-types, a particular voice-type may contain or include an override preventing alteration of certain parameters defined by the voice-type itself.

The speech style sheet 110, the voice style 120, and/or the voice-type 130 may also define other parameters such as rules for speech pronunciation. For example, assume that the speech style sheet 110 is called “Chemistry”, and is associated with a low level markup 112. The low level markup 112 may include rules associated with character, syllable, word, sentence, and/or other speech-related pronunciations. Continuing the example, low level markup 112 defines the rule “if ‘L’ comes after a number, then pronounce as ‘Liters’”. Thus, if text associated with the speech style sheet “Chemistry” 110 includes a text string “22L”, the string will be pronounced as “22 liters” (as opposed to “22 el”). Other speech style sheets 110 and/or voice styles 120 may include pronunciation rules for various speech categories. For example, in other contexts, such as if using a voice style 120 called “Real Estate” (not shown), the same text string may be pronounced as “apartment number twenty-two el”, or simply “22 el”.

System

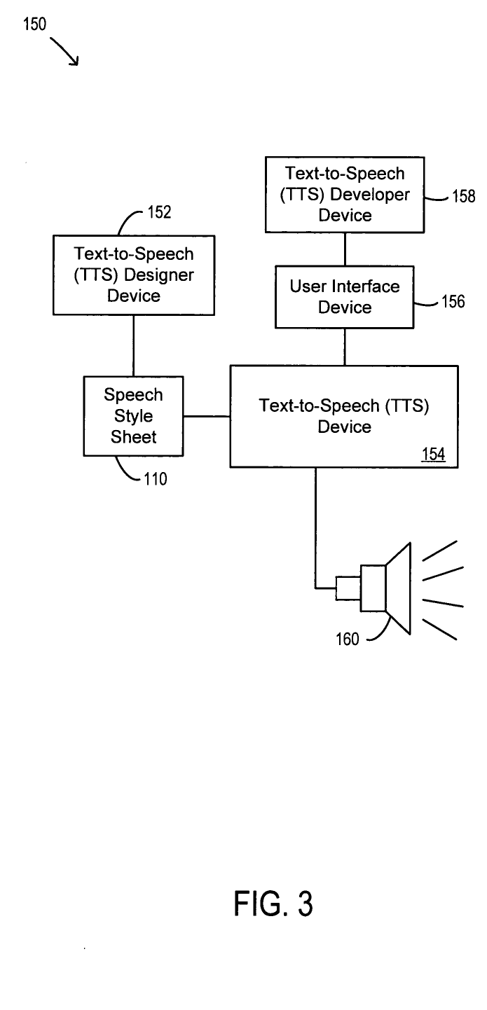

Referring to FIG. 3, a block diagram of a TTS system 150 according to some embodiments is shown. The TTS System 150 may include a TTS designer device 152, a speech style sheet 110, a TTS device 154, a user interface device 156, a TTS developer device 158, and an output device 160. The TTS designer device 152 may be, for example, a computing device used by one or more designers. The TTS designer device 152 may be any known or available type of device capable of creating, editing, or facilitating the creating and/or editing of speech style sheets 110. Examples of such a device include, but are not limited to, a personal computer (PC), a personal digital assistant (PDA), a wireless telephone, pager, and/or communicator, and a digital recorder. The TTS designer device 152 may be or include a single device, or may be composed of multiple devices and/or components. According to some embodiments, a user (such as a TTS designer) may use the TTS designer device 152 to create one or more speech style sheets 110.

The speech style sheet 110 may include one or many components, portions, and/or parts as described herein. In some embodiments, multiple speech style sheets 110 are used in the TTS system 150. The speech style sheet 110, according to some embodiments as described herein, may be created by (or using) the TTS designer device 152. The speech style sheet 110 may, according to some embodiments, be provided or made accessible to the TTS device 154. The TTS device 154 may be any known or available type of TTS device or any component, system, hardware, firmware, software, and/or any combination thereof capable of performing TTS operations. The TTS device 154 may be connected directly to the TTS designer device 152 or may be in intermittent, wireless, and/or continuous communication with either or both of the TTS designer device 152 and the speech style sheet 110. In some embodiments, for example, the TTS device 154 may be a TTS program running on a corporate server or user workstation. The TTS designer device 152 may be, for example, a corporate workstation connected to the corporate server TTS device 154.

In some embodiments, the TTS designer device 152 and the TTS device 154 may not be in communication with each other. Instead, the TTS device 154 may be provided with, connected to, or otherwise have access to the speech style sheet 110 that was created by, for example, the TTS designer device 152. For example, the TTS designer device 152 may be operated by, or on behalf of, a company that creates speech style sheets 110. The company may create a speech style sheet 110 and mail a copy of the speech style sheet 110 (and/or the code that defines the speech style sheet 110) to the corporation that operates the TTS device 154. The speech style sheet 110 may then be loaded into the corporate system and become available to the TTS device 154. In such a manner the TTS device 154 may have access to the speech style sheet 110 without being in direct communication and/or connection with or to the TTS designer device 152. According to some embodiments, the speech style sheet 110 may reside and/or be stored within the TTS device 154.

Connected to the TTS device 154 may be either or both of a user interface device 156 and a TTS developer device 158. The user interface device 156 may be any known or available type of interface device capable of providing an interface between a user and the TTS device 154. Examples of user interface devices 156 may include, but are not limited to, a graphical user interface (GUI) device, a PC, a PDA, a keyboard, a Braille interface device, and a voice interface device. In some embodiments, the TTS developer device 158 and the user interface device 156 may be or include the same device. For example, the user interface device 156 may be a standard or Braille keyboard attached to a PC (TTS developer device 158). In some embodiments the user interface device 156 may reside within, on, or adjacent to, and/or be a part, component, or portion of the TTS device 154. In other embodiments the user interface device 156 may be a separate device in communication with the TTS device 154.

The TTS developer device 158 may be any known or available type of device for developing, creating, and/or editing TTS presentations for conversion to sound and/or speech. In some embodiments, for example, the TTS developer device 158 may be a PC used by, or on behalf of, a TTS developer. In some embodiments, a TTS developer may be an application developer responsible for organizing and designing an IVR menu system. According to some embodiments, the TTS developer may lack the specific aural arts expertise required to create and/or design smooth, flowing, and natural sounding concatenative speech. Those skilled in the art will recognize how the use of speech style sheets as described herein may allow such a person with different skill sets (a TTS developer) to produce expressive TTS presentations. According to some embodiments, a TTS developer using a TTS developer device 158 may also be or include a TTS designer using a TTS designer device 152. The TTS designer device 152 may be, in some embodiments, the same device as the TTS developer device 158.

Also in communication with the TTS device 154 may be, according to some embodiments, an output device 160. The output device 160 may be any known or available type of device capable of producing speech or any other form of sound. According to some embodiments, the output device 160 may be a port, wire, cable, and/or other communication device for transmitting data to a device capable of producing sound. For example, in some embodiments the TTS device 154 is used by a corporation or merchant to produce TTS web pages (auditory web pages) or IVR menus. In such cases, the TTS device 154 may transmit TTS data through a communications port or other output device 160 to one or more telephony devices, for example. The telephony devices may then be accessed by individuals wishing to hear the IVR menu and/or “view” the auditory web page. In some embodiments, the telephony devices themselves may be output devices 160. In some embodiments, the output device 160 may simply be a speaker. According to still other embodiments, the output device 160 may be any type or style of output port, path, or device over and/or through which text with low level markup may be passed, regardless of whether the destination can or may produce sound. For example, text with low level markup may be transmitted via an output device 160 to an external storage device or unit.

### EXAMPLE

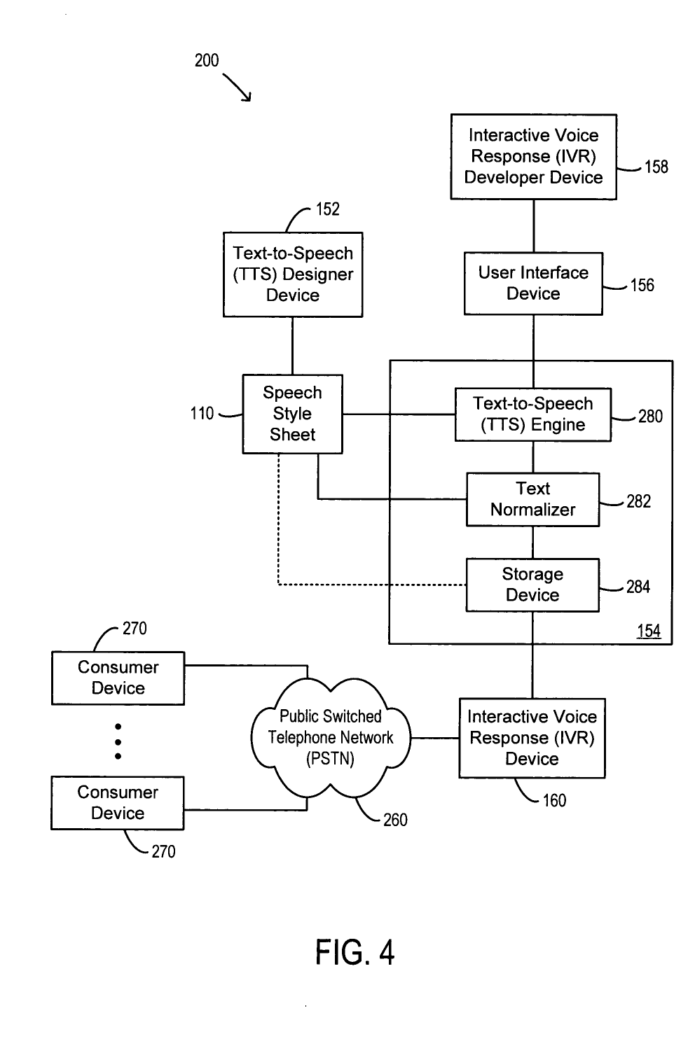

An example of the application of style sheets in a TTS context is provided in reference to FIG. 4, which is a block diagram of a TTS system 200 according to some embodiments. The TTS system 200 may include, for example, a TTS designer device 152, a speech style sheet 110, a TTS device 154, and a user interface device 156, all as described herein in conjunction with TTS system 150. The TTS system 200 may also include an IVR developer device 158, an IVR device 160, a public switched telephone network (PSTN) 260, and one or more consumer devices 270. The IVR developer device 158 may be any device for developing IVR menus, systems, and/or presentations that is known, available, and/or described herein (such as with respect to the TTS developer device 158). In some embodiments, the IVR developer device 158 is a computer and/or computer program for developing IVR menus. For example, a speech style sheet 110 may be created by the TTS designer device 152. The IVR developer device 158 may utilize the user interface device 156 to access, manipulate, control, or otherwise use the TTS device 154 to create an IVR menu using the style sheet 110.

In some embodiments, the TTS device 154 may include components such as a TTS engine 280, a text normalizer 282, and a storage device 284. The TTS engine 280 may be or include a processor for converting text to speech, or may be any other known or available device for performing TTS operations. According to some embodiments, the TTS engine 280 may be controlled by or through the user interface device 156 to convert high level markup to low level markup using, at least in part, the style sheet 110. The text normalizer 282 may be a processor or any other known or available device and/or component for normalizing text. For example, text with high level markup regarding speech properties may be processed (converted to low level markup) by the TTS engine 280, while text with high level markup regarding pronunciation rules may be processed by the text normalizer 282.

Also according to some embodiments, the TTS device 154 may include one or more storage devices 284. The storage device 284 may be any known or available type of storage device including, but not limited to, a hard drive, a tape and/or floppy disk drive, random access memory (RAM), cache, and/or a digital video disk (DVD). The storage device 284 may be in communication with one or more of the other components of the TTS device 154, and may be used, for example, to store the low level markup, the text with high level markup, and/or the processed text received from either or both of the TTS engine 280 and the text normalizer 282. In some embodiments, the storage device 284 may have access to and/or store the style sheet 110. For example, the storage device 284 may be or include a database that stores the style sheet 110 and/or its associated information or code. The TTS device 154 and its respective components 280, 282 may accordingly have local access to the style sheet 110.

In some embodiments, for example, a TTS developer may be an IVR designer and a TTS designer may be an aural artist or voice expert. The TTS designer may use a TTS designer device 152 such as a PC, to create one or more style sheets 110. The TTS developer may then use the IVR developer device 158 such as a PC, to access a user interface device 156 such as a GUI. An example of such a user interface device 156 may be, for example, a software-implemented browser application. Using the user interface device 156, the TTS developer may access the style sheets 110 created by the TTS designer. The style sheet 110 may be used, for example, by the TTS device 154 to convert high level markup to low level markup. The TTS engine 280 may convert high level markup regarding speech properties, and the text normalizer 282 may convert high level markup regarding pronunciation and/or other speech rules. The style sheet 110 accessed by, for example, the TTS engine 280 and the text normalizer 282, may reside in the storage device 284 of the TTS device 154, or may be external to the TTS device 154. The storage device 284 may also store the low level markup provided by either or both of the TTS engine 280 and the text normalizer 282. In some embodiments, such low level markup may be or include a TTS presentation such as an IVR menu and/or program code associated with an IVR menu.

The low level markup may, according to some embodiments, be provided and/or transmitted to an IVR device 160. The IVR device 160 may be any device associated with IVR systems including an IVR server or an IVR program, and/or may be any other known or available device or any device as described herein (such as in conjunction with output device 160). In some embodiments, the IVR device 160 may be an IVR system capable of presenting IVR menus to various other devices and/or entities. The IVR device 160 may be connected to and/or in communication with one or more networks including, for example, a PSTN 260. Various consumer devices 270 may also be connected to and/or in communication with the PSTN 260, and thus may also have access to the IVR device 160. In some embodiments, the TTS device 154 and the IVR device 160 may be or comprise the same device.

For example, an IVR developer may use an IVR developer device 158 to access and control a TTS device 154. Through the TTS device 154, the IVR developer may have access to a library of speech style sheets 110 which may, for example, have been created by an aural artist using a TTS designer device 152. In an illustrative example, the IVR developer may be a developer of an Airline's IVR menu system, and the aural artist may be a style sheet designer employed by a separate TTS company that designs and markets style sheets and/or TTS software. The TTS device 154 may be, for example, TTS software marketed by the TTS company.

Continuing the illustrative example, the IVR developer may need to develop code for an IVR response to a consumer query for available flight information. One of the available speech style sheets 110 may be called “Airline”, and may contain voice styles 120 called “happy” and “apologetic”. The IVR developer may code the IVR menu, for example, to provide a response in a different voice style 120 depending upon the result of a flight availability query. For example, a consumer may operate a consumer device 270 such as a wired, wireless, and/or cellular telephone to dial a telephone number associated with the IVR device 160 which may, for example, be operated by, or on behalf of, the Airline company. The IVR device 160 and the consumer device 270 may be connected via the PSTN 260. The consumer may, for example, query the IVR system as to the availability of a flight from New York to Washington, D.C. on the afternoon of a particular date. The text associated with the results of the query may read “there is a flight during the time you requested” (a positive query result), or “there is a flight in the evening” (a negative query result). The IVR developer may associated a positive query result with the voice style 120 “happy” and a negative query response with the voice style 120 “apologetic”, for example.

The voice style 120 “happy” may define low level markup including a rule to precede “happy” text with the phrase (or derivations of the phrase) “You'll be glad to know that . . . ” While the voice style 120 “apologetic” may define a low level markup including a rule to precede “apologetic” text with the phrase “Well, . . . ” A positive query result may thus be spoken to the consumer as “You'll be glad to know that there is a flight during the time you requested.” While a negative query result may be spoken as “Well, there is a flight in the evening.” Those skilled in the art will appreciate that expressive speech (such as the negative query result, for example) may reduce the amount of spoken information that must be delivered to the consumer.

For example, a typical IVR system that needs to represent the negative query result may need to both describe to the consumer that there is no flight available at the requested time and present alternatives, explaining that the alternatives were chosen as close to the requested time as was possible. In some current embodiments, as described above for example, an expressively spoken statement may convey all the required information to the consumer without requiring additional text or speech. For example, the “apologetic” negative query response “Well, there is a flight in the evening” indicates that no flight was available during the requested time, but the next closest available flight is in the evening. Also, because the phrase is spoken in an “apologetic” style, the consumer is made aware that the IVR system is sorry for not being able to locate a flight during the requested time.

Apparatus

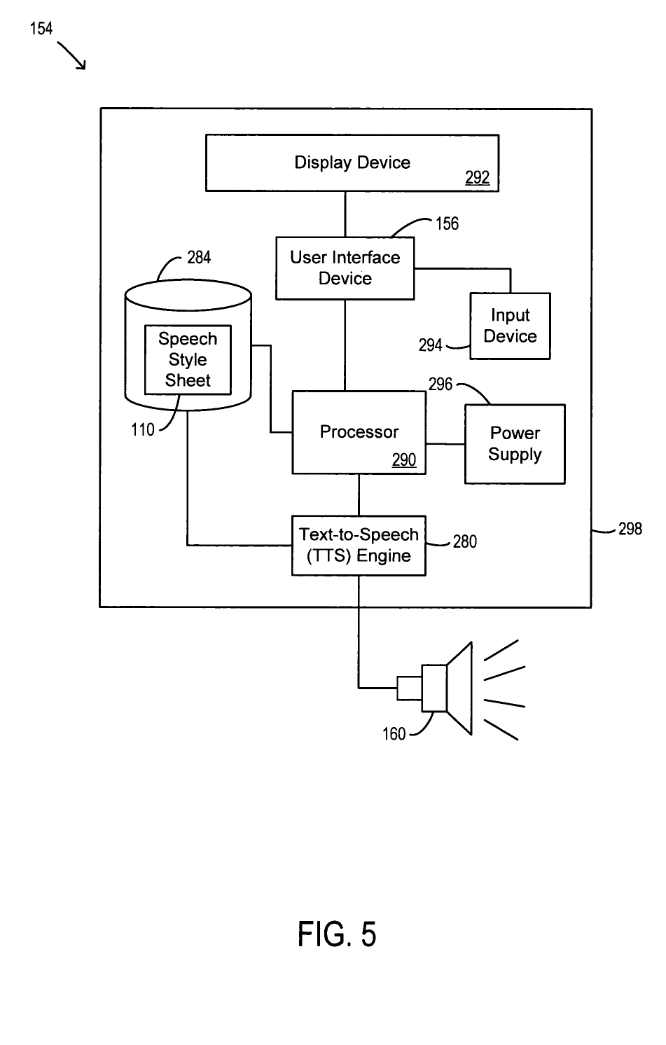

FIG. 5 shows a block diagram of a TTS device 154 in accordance with some embodiments. The TTS device 154 may include a user interface device 156, an output device 160, a TTS engine 280, a storage device 284, a processor 290, a display device 292, an input device 294, a power supply 296, and a casing 298. The TTS device 154 may be or include, for example, a TTS device 154 as described in conjunction with various TTS systems 150, 200 herein. In some embodiments, the TTS device 154 may contain and/or comprise fewer or more components than those shown in FIG. 5.

For example, the TTS device 154 may be a portable device for converting text to speech. Such a device may be used, for example, by an individual with sensory impairment in order to facilitate communication between the individual and one or more other individuals and/or devices. The user interface device 156 may be or include a user interface device 156 as described elsewhere herein, or may be any other type of known or available device for allowing a user to interact with and/or control the TTS device 154 and/or any of its components. The user interface device 156 may be, for example, a software GUI. The GUI may be displayed to a user via the display device 292, which may be, for example, a cathode-ray tube (CRT), liquid-crystal display (LCD), or other display device. The user may interact with and provide input to the user interface device 156 using an input device 294. The input device 294 may be or include any of various types of input devices including keyboards, pointing devices, trackballs, and touch screens. In some embodiments, the user interface device 156 and the input device 294 may be or include the same device (such as with touch screens).

The TTS device 154 may include a processor 290. The processor 290 may, for example, process inputs received from either or both of the user interface device 156 and the input device 294. The processor 290 may, according to some embodiments, run program code associated with the user interface 156 such as when the user interface 156 is a GUI. The processor 290 may require power and/or energy which may be supplied by a power supply 296. The power supply 296 may be any type and/or source of power capable of satisfying the needs of the processor 290 and/or other components of the TTS device 154. In some embodiments, for example, the power supply 296 may be or include a battery such as a rechargeable battery. The processor 290 may be in communication with and/or otherwise have access to a storage device 284. The storage device 284 may be any known or available storage means such as those described elsewhere herein. The storage device 284 may be or include a database and may store and/or have access to one or more style sheets 110. The processor 290 may access the storage device 284, for example, to retrieve style sheet information from the style sheet 110. For example, the processor 290 may access the storage device 284 and the style sheet 110 to determine a list of high level markups and associated voice styles that are available for use in and/or by the user interface device 156. Such a list may then be presented and/or provided to a user operating the TTS device 154.

The TTS device 154 may also include a TTS engine 280 which may be a device as described elsewhere herein, or may be any other type of processing and/or logical or computational device known or available. The TTS engine 280 may, for example, process text with high level markup received from the user interface device 156. The TTS engine 280 may access the storage device 284 and the style sheet 110 to convert, for example, the high level text markup to its associated low level markup. The low level markup may then be sent to another device for storage (such as storage device 284) or for the production of speech (such as output device 160). In some embodiments, the TTS engine 280 and the processor 290 may be or include the same device.

In some embodiments, output device 160 may be a device external to the TTS device 154. In other embodiments, the output device 160 may be or include a speaker, for example, and may reside within and/or attached to the TTS device 154 and/or any of its components. The output device 160 may, for example, receive text with low level markup from either or both the TTS engine 280 and the processor 290. In some embodiments the output device 160 may receive and/or retrieve text with low level markup from the storage device 284. For example, a user may create a TTS presentation using the TTS device 154 and may store the presentation in the storage device 284. The presentation may then be recalled at some later time and sent to the output device 160 for the production of speech sounds in accordance with the low level markup of the presentation. Also according to some embodiments, any and/or all of the components of the TTS device 154 described herein may reside within and/or be attached to the casing 298. The casing 298 may be, for example, a plastic, metal, or other material case for housing the components of the TTS device 154. In some embodiments, the casing 298 may be a computer case. Also according to some embodiments, the TTS device 154 may be or include a PC or other computing device. In some embodiments, the TTS device 154 may be used to produce expressive TTS for us in e-mail, chat, and/or instant messaging applications.

Although some exemplary embodiments have been described with respect to various embodiments thereof, those skilled in the art will note that various substitutions may be made to those embodiments described herein without departing from the spirit and scope of the present invention.

1. A method, comprising:
identifying text to convert to speech;
selecting a speech style sheet from a set of available speech style sheets, said speech style sheet defining desired speech characteristics;
marking said text to associate said text with said selected speech style sheet; and
converting said text to speech having said desired speech characteristics by applying a low level markup generated by said speech style sheet.

2. A method according to claim 1, further comprising:
sending said text with said low level markup to an output device.

3. A method according to claim 1, further comprising:
identifying at least one low level markup;
defining a voice style at least in part by associating said voice style with said at least one low level markup; and
associating a speech style sheet with said voice style.

4. A method according to claim 3, wherein said associating said speech style sheet with said voice style includes:
creating said speech style sheet.

5. A method according to claim 3, wherein said associating said speech style sheet with said voice style includes:
editing said speech style sheet.

6. A method according to claim 1, wherein said low level markup defines at least one of a pitch, a prosody, a voice quality, a duration, a tremor, a timbre, a speed, an intonation, a timing, a volume, and a pronunciation rule.

7. A method according to claim 1, further comprising:
providing said speech style sheet to at least one of a text-to-speech developer and a text-to-speech device.

8. A method according to claim 1, further comprising:
compiling a library of speech style sheets.

9. A method according to claim 1, further comprising:
identifying at least one low level markup;
associating a speech style sheet with said at least one low level markup.

10. A method according to claim 1, wherein said speech style sheet is selected from a menu of available speech style sheets.

11. A method according to claim 1, wherein said marking of said text includes annotating said text with an annotation such as underlining, bolding, italicizing, highlighting, color-coding, coding, adding a symbol, a mark, or a design.

12. A method according to claim 1, wherein said converting said text to speech includes:
identifying said low level markup associated with said speech style sheet; and
converting said marking of said text to said low level markup.

13. A method according to claim 1, wherein said marking of said text further associates said text with a voice style associated with said speech style sheet.

14. A method according to claim 13, wherein said voice style represents at least one of an age, an educational level, an emotion, a feeling, a physical trait, a personality trait, and a speech category.

15. A method according to claim 1, wherein said low level markup allows a text-to-speech developer to convey a certain amount of information using less text.

16. A method according to claim 1, wherein said selecting is performed by a text-to-speech developer not having expertise in voice arts.

17. A speech style sheet, comprising:
at least one voice style associated with at least one voice-type, said at least one voice style relating a high level markup of said voice-type to a low level markup of said voice-type.

18. The speech style sheet according to claim 17, wherein said high level markup of said voice-type is a text markup.

19. The speech style sheet according to claim 17, wherein said high level markup includes at least one of an underlining, a bolding, an italicizing, a highlighting, a color-coding, an annotation, a coding, and an application of at least one of a symbol, a mark, and a design.

20. The speech style sheet according to claim 17, wherein said low level markup of said voice-type includes code causing generation of speech having particular speech properties.

21. The speech style sheet according to claim 17, wherein said low level markup defines at least one of a pitch, a prosody, a voice quality, a duration, a tremor, a timbre, a speed, an intonation, a timing, a volume, and a pronunciation rule.

22. The speech style sheet according to claim 17, wherein said at least one voice style represents style characteristics such as an age, an educational level, an emotion, a feeling, a physical trait, a personality trait, and a speech category.

23. The speech style sheet according to claim 17, wherein said speech style sheet is at least one of a programming object, a programming module, a computer program, or a computer file.

24. An apparatus, comprising:
a processor having access to at least one speech style sheet, said at least one speech style sheet containing a definition of a voice style associated with a voice-type, and said definition relating a high level markup of said voice-type to a low level markup of said voice-type, wherein said processor is operative to convert said high level markup to said low level markup;
a user interface device for applying said at least one voice style to text associated with said voice-type, said user interface being in communication with said processor; and
an output device connected to said processor for converting said text with said low level markup to speech.

25. The apparatus of claim 24, wherein said processor includes at least one of a text-to-speech engine and a text normalizer.

26. The apparatus according to claim 24, wherein said low level markup defines at least one of a pitch, a prosody, a voice quality, a duration, a tremor, a timbre, a speed, an intonation, a timing, a volume, and a pronunciation rule.

27. The apparatus according to claim 24, wherein said high level markup includes at least one of an underlining, a bolding, an italicizing, a highlighting, a color-coding, an annotation, a coding, and an application of at least one of a symbol, a mark, and a design.

28. The apparatus according to claim 24, wherein said voice style represents at least one of an age, an educational level, an emotion, a feeling, a physical trait, a personality trait, and a speech category.

29. A system, comprising:
a designer device for creating speech style sheets;
a speech style sheet at least partially created by said designer device, said speech style sheet defining a voice style;
a text-to-speech device for receiving text associated with a voice-type, said text having a high level markup associated with said voice style, said text-to-speech device having access to said speech style sheet and also having:
a memory for storing computer executable code; and
a processor for executing the program code stored in memory, wherein the program code includes;
code to determine, by accessing said speech style sheet, a low level markup associated with said high level markup; and
code to convert said high level markup of said text to said low level markup; and
an output device for producing expressive speech using said text with said low level markup, said output device in communication with said text-to-speech device.

30. The system according to claim 29, further comprising:
a developer device in communication with said text-to-speech device, said developer device for marking text and providing said text to said text-to-speech device.

31. The system according to claim 29, further comprising:
a user interface device in communication with said text-to-speech device, said user interface device for applying high level markup to text and providing said text to said text-to-speech device.

32. An article of manufacture, comprising:
a computer usable medium having computer readable program code means embodied therein for producing expressive text-to-speech, comprising:
computer readable program code means for identifying text to convert to speech;
computer readable program code means for selecting a speech style sheet from a set of available speech style sheets, said speech style sheet defining desired speech characterstics;
computer readable program code means for marking said text to associate said text with said selected speech style sheet; and
computer readable program code means for converting said text to speech having said desired speech characteristics by applying a low level markup associated with said speech style sheet.

33. A system for producing expressive text-to-speech, comprising:
means for identifying text to convert to speech;
means for selecting a speech style sheet from a set of available speech style sheets, said speech style sheet defining desired speech characteristics;
means for marking said text to associate said text with said selected speech style sheet; and
means for converting said text to speech having said desired speech characteristics by applying a low level markup associated with said speech style sheet.
